(19) United States
(12) Patent Application Publication
(10) Pub. No.: US 2020/0180103 A1
(43) Pub. Date: Jun. 11, 2020

(54) APPARATUS AND METHOD FOR MONITORING CHEMICAL MECHANICAL POLISHING

(71) Applicant: Samsung Display Co., Ltd., Yongin-si (KR)

(72) Inventors: Sangheon YE, Cheonan-si (KR); Seyoon OH, Yongin-si (KR); Seonghyeon CHEON, Gwacheon-si (KR)

(21) Appl. No.: 16/582,658

(22) Filed: Sep. 25, 2019

(30) Foreign Application Priority Data
Dec. 5, 2018 (KR) 10-2018-0155045

(51) Int. Cl. B24B 49/12; B24B 37/005; B24B 37/27; B24B 37/34; B24B 53/017; G01B 11/06

(52) U.S. Cl. CPC B24B 49/12; B24B 37/005; G01B 11/06; B24B 37/34; B24B 53/017; B24B 37/27

(57) ABSTRACT

An apparatus for monitoring polishing includes a substrate transferring unit configured to transfer a substrate including at least one inorganic layer along a first direction; a polishing unit on the substrate transferring unit; a cleaning unit and a drying unit on the substrate transferring unit; and a monitoring unit on the substrate transferring unit, the monitoring unit including a plurality of optical probes configured to measure reflected lights reflected from respective ones of a plurality of different positions of the substrate. The polishing unit, the cleaning unit, the drying unit, and the monitoring unit are sequentially located along the first direction.

### CROSS-REFERENCE TO RELATED APPLICATION

This application claims priority to and the benefit of Korean Patent Application No. 10-2018-0155045, filed on Dec. 5, 2018, in the Korean Intellectual Property Office (KIPO), the entire content of which is incorporated herein by reference.

### BACKGROUND

### 1. Field

Embodiments of the present disclosure relate to an apparatus for monitoring polishing and to a method for monitoring polishing.

### 2. Discussion of Related Art

In general, display pixels are formed on a substrate by sequentially depositing, for example, a conductive layer, a semiconductor layer, and insulating layers. Because the conductive layer, the semiconductor layer, and the like are patterned, the insulating layer on the conductive layer and the semiconductor layer are not planarized. An upper surface of the substrate on which the display pixels are located may be planarized by using chemical mechanical polishing (CMP).

It is to be understood that this background of the technology section is intended to provide useful background for understanding the technology and as such disclosed herein, the technology background section may include ideas, concepts or recognitions that were not part of what was known or appreciated by those skilled in the pertinent art prior to a corresponding effective filing date of subject matter disclosed herein.

### SUMMARY

Embodiments of the present disclosure may be directed to an apparatus and a method for monitoring polishing capable of accurately determining an end point of a polishing process and measuring evenness of an object.

According to an embodiment, an apparatus for monitoring polishing includes a substrate transferring unit configured to transfer a substrate that may include at least one inorganic layer along a first direction; a polishing unit on the substrate transferring unit; a cleaning unit and a drying unit on the substrate transferring unit; and a monitoring unit on the substrate transferring unit, and including a plurality of optical probes configured to measure reflected lights reflected from a plurality of different positions of the substrate, respectively. The polishing unit, the cleaning unit, the drying unit, and the monitoring unit are sequentially located along the first direction.

The plurality of optical probes may be arranged apart from each other along a second direction that is perpendicular (e.g., substantially perpendicular) to the first direction.

The substrate may include a plurality of cells arranged along the first direction and a second direction that is perpendicular (e.g., substantially perpendicular) to the first direction, and the plurality of optical probes may be located corresponding to the cells of the substrate, respectively.

The apparatus may further include a thickness-spectrum database including data on thicknesses of the inorganic layer, and reference spectra corresponding to the thicknesses of the inorganic layer, respectively.

The thickness-spectrum database may include data on polishing times corresponding to the thicknesses of the inorganic layer, respectively.

The apparatus may further include a multi-channel spectroscope coupled to the plurality of optical probes, and calculating spectra from the reflected lights measured by the plurality of optical probes, respectively.

The apparatus may further include a controller configured to compare the plurality of calculated spectra with the reference spectra.

The controller may compare wavelengths at a peak point and a valley point of a spectrum calculated by the multi-channel spectroscope with wavelengths at a peak point and a valley point of the reference spectrum, respectively.

The controller may compare the plurality of calculated spectra with each other.

According to another embodiment, a method for monitoring polishing includes: generating a thickness-spectrum database; polishing a substrate that may include at least one inorganic layer; concurrently (e.g., simultaneously) calculating spectra for a plurality of different positions of the substrate, respectively; comparing each of the calculated spectra with reference spectra included in the thickness-spectrum database; calculating respective thicknesses of the inorganic layer at the plurality of different positions of the substrate; and determining properness of the respective thicknesses of the inorganic layer at the plurality of different positions of the substrate.

When concurrently (e.g., simultaneously) calculating the respective spectra for the plurality of different positions of the substrate, the plurality of different positions of the substrate may correspond to a plurality of respective cells included in the substrate.

The determining of the properness of the thicknesses of the inorganic layer at the plurality of different positions of the substrate may include: comparing respective thicknesses calculated for the plurality of different positions of the substrate with each other; and determining evenness of the inorganic layer.

The thickness-spectrum database may include data on thicknesses of the inorganic layer, and reference spectra corresponding to the thicknesses of the inorganic layer, respectively.

The thickness-spectrum database may include data on polishing times corresponding to the thicknesses of the inorganic layer, respectively.

The concurrently (e.g., simultaneously) calculating of the spectra for the plurality of different positions of the substrate, respectively, may include: measuring reflected lights that are reflected from the plurality of different positions of the substrate, respectively; and decomposing each of the reflected lights of the substrate according to wavelength.

The comparing of each of the calculated spectra with the reference spectra included in the thickness-spectrum database may include: comparing wavelengths at a peak point and a valley point of the calculated spectrum with wavelengths at a peak point and a valley point of the reference spectrum, respectively.

The concurrently (e.g., simultaneously) calculating of the spectra for the plurality of different positions of the substrate, respectively, may include: measuring a luminous intensity of each of the reflected lights according to a wavelength of about 400 nm or more and about 900 nm or less.

The generating of the thickness-spectrum database may include: performing a polishing process on each of the plurality of substrates, each including at least one inorganic layer; calculating a spectrum for each of the plurality of substrates; measuring a thickness of the inorganic layer of each of the plurality of substrates using a transmission electron microscope (TEM); and calculating a thickness of the inorganic layer and a reference spectrum for each of the plurality of substrates corresponding to the thickness of the inorganic layer.

According to another embodiment, a method for monitoring polishing includes: performing a polishing process on each of a plurality of substrates, each including at least one inorganic layer; calculating a spectrum for each of the plurality of substrates; measuring a thickness of the inorganic layer of each of the plurality of substrates using a transmission electron microscope (TEM); and calculating a thickness of the inorganic layer and a reference spectrum for each of the plurality of substrates corresponding to the thickness of the inorganic layer.

The calculating of the thickness of the inorganic layer and the reference spectrum for each of the plurality of substrates corresponding to the thickness of the inorganic layer may include: calculating wavelengths at a peak point and a valley point of the reference spectrum corresponding to the thickness of the inorganic layer.

The foregoing is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

A more complete appreciation of the subject matter of the present disclosure will become more apparent by describing in more detail embodiments thereof with reference to the accompanying drawings, in which:

FIG. 1 is a schematic view illustrating an apparatus for monitoring polishing according to an embodiment;

FIG. 2 is a block diagram illustrating an apparatus for monitoring polishing according to an embodiment;

FIG. 3 is a block diagram illustrating a monitoring unit according to an embodiment;

FIG. 4 is a plan view illustrating area A in FIG. 1;

FIG. 5 is a cross-sectional view illustrating a substrate before polishing;

FIG. 6 is a cross-sectional view illustrating a substrate after polishing;

FIG. 7 is a view illustrating spectra of reflected lights according to a degree of polishing;

FIG. 8 is a flowchart illustrating a method for generating a thickness-spectrum database according to an embodiment; and

FIG. 9 is a flowchart illustrating a method for monitoring polishing according to an embodiment.

### DETAILED DESCRIPTION

Embodiments will now be described more fully hereinafter with reference to the accompanying drawings. Although the subject matter of the present disclosure may be modified in various manners and have several embodiments, certain embodiments are illustrated in the accompanying drawings and will be mainly described in the specification. However, the scope of the present disclosure is not limited to the described embodiments and should be construed as including all the changes, equivalents and substitutions included in the spirit and scope of the present disclosure.

In the drawings, thicknesses of a plurality of layers and areas may be illustrated in an enlarged manner for clarity and ease of description thereof. When a layer, area, or plate is referred to as being “on” another layer, area, or plate, it may be directly on the other layer, area, or plate, or intervening layers, areas, or plates may be present therebetween. Conversely, when a layer, area, or plate is referred to as being “directly on” another layer, area, or plate, intervening layers, areas, or plates may be absent therebetween. Further when a layer, area, or plate is referred to as being “below” another layer, area, or plate, it may be directly below the other layer, area, or plate, or intervening layers, areas, or plates may be present therebetween. Conversely, when a layer, area, or plate is referred to as being “directly below” another layer, area, or plate, intervening layers, areas, or plates may be absent therebetween.

The spatially relative terms “below”, “beneath”, “lower”, “above”, “upper” and the like, may be used herein for ease of description to describe the relations between one element or element and another element or element as illustrated in the drawings. It will be understood that the spatially relative terms are intended to encompass different orientations of the device in use or operation, in addition to the orientation illustrated in the drawings. For example, in a case where a device illustrated in the drawing is turned over, the device positioned “below” or “beneath” another device may be placed “above” another device. Accordingly, the illustrative term “below” may include both the lower and upper positions. The device may also be oriented in the other direction, and thus, the spatially relative terms may be interpreted differently depending on the orientations.

Throughout the specification, when an element is referred to as being “connected” or “coupled” to another element, the element is “directly connected” or “directly coupled” to the other element, or “electrically connected” or “electrically coupled” to the other element with one or more intervening elements interposed therebetween. It will be further understood that the terms “comprises,” “comprising,” “includes” and/or “including,” when used in this specification, specify the presence of stated features, integers, actions, operations, and/or elements, but do not preclude the presence or addition of one or more other features, integers, actions, operations, elements, and/or groups thereof. As used herein, the term “and/or” includes any and all combinations of one or more of the associated listed items. Expressions such as “at least one of,” when preceding a list of elements, modify the entire list of elements and do not modify the individual elements of the list.

It will be understood that, although the terms “first,” “second,” “third,” and the like may be used herein to describe various elements, these elements should not be limited by these terms. These terms are only used to distinguish one element from another element. Thus, “a first element” discussed below could be termed “a second element” or “a third element,” and “a second element” and “a third element” may be termed likewise without departing from the spirit and scope of the present disclosure.

The terms “about” or “approximately,” as used herein, are inclusive of the stated value and means within an acceptable range of deviation for the particular value as determined by one of ordinary skill in the art, considering the measurement in question and the error associated with measurement of the particular quantity (e.g., the limitations of the measurement system). For example, as used herein, the term “about” may mean within one or more standard deviations, or within ±30%, 20%, 10%, or 5% of the stated value. Further, the use of “may” when describing embodiments of the present disclosure refers to “one or more embodiments of the present disclosure.” As used herein, the terms “use,” “using,” and “used” may be considered synonymous with the terms “utilize,” “utilizing,” and “utilized,” respectively. Also, the term “exemplary” is intended to refer to an example or illustration.

Unless otherwise defined, all terms used herein (including technical and scientific terms) have the same meaning as commonly understood by those skilled in the art to which this disclosure pertains. It will be further understood that terms, such as those defined in commonly used dictionaries, should be interpreted as having a meaning that is consistent with their meaning in the context of the relevant art and will not be interpreted in an ideal or excessively formal sense unless clearly defined in the present specification.

Some of the parts which are not associated with the following description may not be described in order to more clearly describe embodiments of the present disclosure. Like reference numerals refer to like elements throughout the specification.

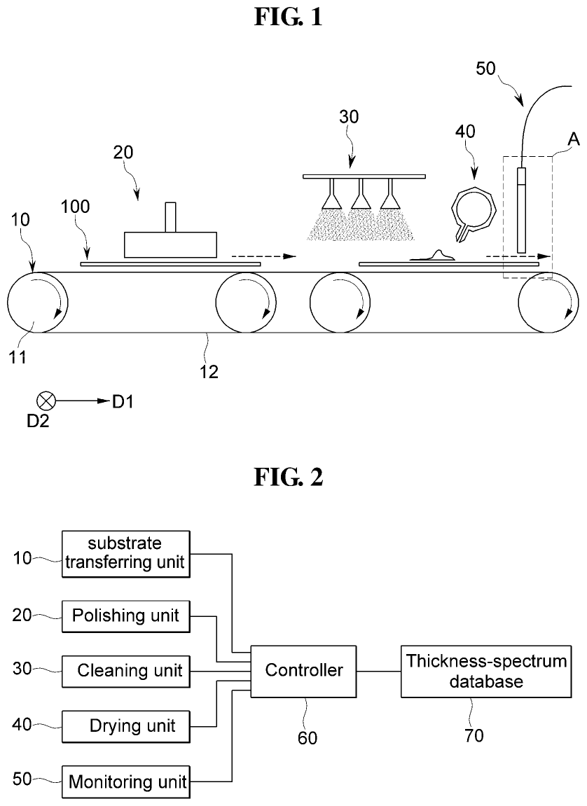

Hereinafter, an apparatus for monitoring polishing according to an embodiment will be described in more detail with reference to FIGS. 1 to 4.

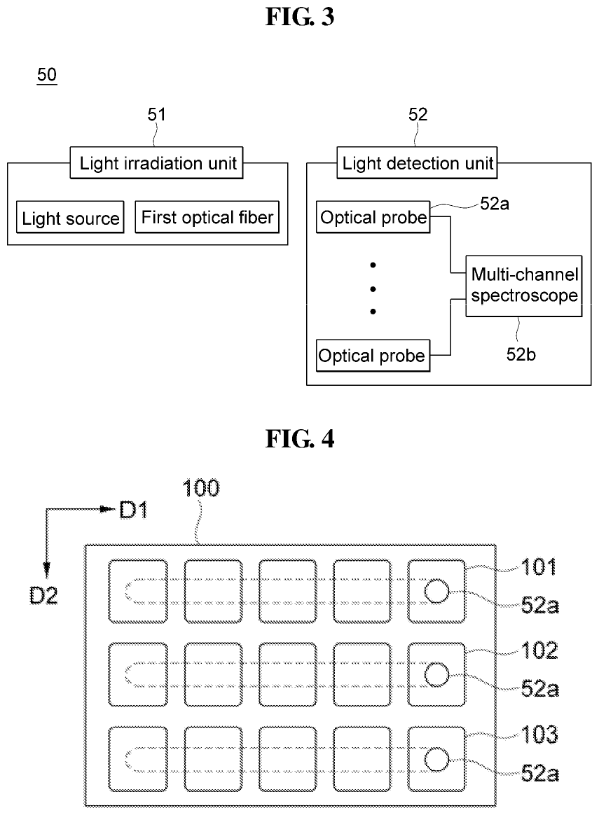

FIG. 1 is a schematic view illustrating an apparatus for monitoring polishing according to an embodiment, FIG. 2 is a block diagram illustrating an apparatus for monitoring polishing according to an embodiment, FIG. 3 is a block diagram illustrating a monitoring unit 50 according to an embodiment, and FIG. 4 is a plan view illustrating area A in FIG. 1.

Referring to FIGS. 1 and 2, an apparatus (e.g., a system) for monitoring polishing according to an embodiment includes a substrate transferring unit 10, a polishing unit 20, a cleaning unit 30, a drying unit 40, a monitoring unit 50, a controller 60, and a thickness-spectrum database 70.

The substrate transferring unit 10 transfers a substrate 100 on the substrate transferring unit 10 along a first direction D1. For example, the substrate transferring unit 10 may be a conveyor apparatus, and the substrate transferring unit 10 may include a plurality of rotary members 11 and a conveyor belt 12. In such an embodiment, the plurality of rotary members 11 may move the conveyor belt 12 along the first direction D1 so that the substrate 100 on the conveyor belt 12 may be transferred along the first direction D1.

The substrate transferring unit 10 may be unitarily formed and below the polishing unit 20, the cleaning unit 30, the drying unit 40, and the monitoring unit 50. However, embodiments are not limited thereto, and the number of the substrate transferring units 10 may include a plurality of substrate transferring units.

The polishing unit 20 polishes an upper surface of the substrate 100 on the substrate transferring unit 10. For example, the polishing unit 20 may be a chemical mechanical polishing (CMP) apparatus. In some embodiments, the polishing unit 20 may include a polishing table, a platen, and/or a slurry feeder.

The polishing table may include a polishing pad, and may have a rotatable disk shape at which the polishing pad may be seated. The polishing table may be operated to rotate with respect to an axis. For example, a motor may rotate a drive shaft to rotate the polishing table.

The platen is positioned below the conveyor belt 12 of the substrate transferring unit 10 to support the substrate 100 so that the polishing table may be applied.

The slurry feeder may supply a slurry solution utilized or required for the chemical mechanical polishing process onto the polishing pad. The substrate 100 on the substrate transferring unit 10 may be polished by contacting the polishing pad in a sliding manner in the presence of the slurry solution.

The cleaning unit 30 is between the polishing unit 20 and the drying unit 40 on the substrate transferring unit 10. The cleaning unit 30 may clean foreign matters, generated on the substrate 100 due to polishing, by spraying a cleaning solution, e.g., de-ionized water (DI).

The drying unit 40 is between the cleaning unit 30 and the monitoring unit 50 on the substrate transferring unit 10. The drying unit 40 removes the cleaning solution remaining at the substrate 100 that was cleaned. The drying unit 40 may include, for example, an air unit, a suction unit, a drying unit, and an unloading head.

The air unit blows an air using an air knife to remove the cleaning solution remaining at the substrate 100. In such an embodiment, the air knife may be an air injector that has various suitable structures, and may blow air at, for example, room temperature. However, embodiments are not limited thereto. The suction unit removes the cleaning solution remaining at the substrate 100 through suction. The drying unit lastly dries moisture remaining at an upper or lower surface of the substrate 100 by hot air drying.

The monitoring unit 50 receives light reflected from the substrate 100. In some embodiments, the monitoring unit 50 includes a light irradiation unit 51 and a light detection unit 52. The light irradiation unit 51 emits a light to the substrate 100. To this end, the light irradiation unit 51 may include a light source and a first optical fiber. In such an embodiment, the light source may emit infrared light rays and/or visible light rays.

The light detection unit 52 receives each of lights reflected from different positions of the substrate 100. To this end, the optical detection unit 52 may include a plurality of optical probes 52a and a multi-channel spectrometer 52b.

Each of the optical probes 52a may include a second optical fiber to be coupled to the multi-channel spectroscope 52b. Accordingly, the reflected light of the substrate 100 that is input to the optical probe 52a may be input to the multi-channel spectroscope 52b through the second optical fiber.

The multi-channel spectroscope 52b receives the reflected lights through the plurality of optical probes 52a, respectively. In some embodiments, the multi-channel spectroscope 52b decomposes each of the reflected lights input thereto according to wavelength, and measures a luminous intensity over a set or predetermined wavelength range. For example, the multi-channel spectroscope 52b decomposes each of the reflected lights input thereto for each wavelength in a range of about 400 nm to about 900 nm, and calculates a spectrum. However, embodiments are not limited thereto, and the luminous intensity may be measured for a wavelength range of about 400 nm or less and about 900 nm or more.

According to an embodiment, the plurality of optical probes 52a are arranged along a second direction D2 that is perpendicular (e.g., substantially perpendicular) to the first direction D1. In some embodiments, the substrate 100 may include a plurality of cells 101, 102, and 103, and the plurality of optical probes 52a may be located to correspond to the plurality of cells 101, 102, and 103 of the substrate 100, respectively. For example, as illustrated in FIG. 4, one optical probe 52a may be arranged on each of the three cells 101, 102, and 103 along the second direction D2. However, the number of the optical probes 52a is not limited thereto, and may vary depending on the number of cells 101, 102, and 103 arranged along the second direction D2.

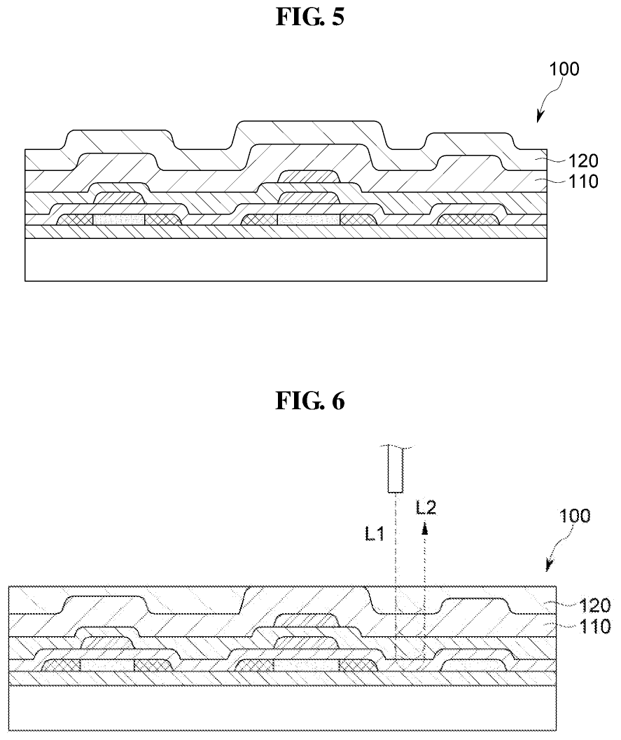

Because the substrate 100 may move at a constant speed along the first direction D1 by the substrate transferring unit 10, and because the optical probes 52a are arranged apart from each other along the second direction D2, as illustrated in FIG. 3, spectra of the reflected lights measured over a wide area of the substrate 100 may be calculated. Accordingly, a method for monitoring polishing according to an embodiment may accurately measure evenness of a second inorganic layer (120 in FIG. 5).

According to an embodiment, the polishing unit 20, the cleaning unit 30, the drying unit 40 and the monitoring unit 50 are sequentially arranged along the first direction D1. Accordingly, respective processes of the polishing unit 20, the cleaning unit 30, the drying unit 40 and the monitoring unit 50 are sequentially performed on the substrate 100 that is transferred by the substrate transferring unit 10 along the first direction D1.

The controller 60 may control operations of the substrate transferring unit 10, the polishing unit 20, the cleaning unit 30, the drying unit 40 and the monitoring unit 50.

The controller 60 may control a moving speed of the substrate 100. In some embodiments, the controller 60 may control a moving speed of the conveying belt 12 of the substrate transferring unit 10 by adjusting a rotating speed of the rotary member 11 of the substrate transferring unit 10.

According to an embodiment, the controller 60 may control a polishing time (e.g., a period of time for performing the polishing process) of the polishing unit 20 by calculating an end point of a polishing process based on the thickness-spectrum database 70.

The controller 60 may adjust operation times of the cleaning unit 30 and the drying unit 40 according to the polishing time.

According to an embodiment, the controller 60 may calculate the end point of the polishing process and a thickness of the second inorganic layer 120 by comparing the spectrum calculated by the monitoring unit 50 with a reference spectrum. For example, the controller 60 may calculate the thickness of the second inorganic layer 120 by selecting a reference spectrum that has a peak point or a valley point at a wavelength substantially the same as a wavelength at which the spectrum calculated by the monitoring unit 50 has a peak point or a valley point. According to an embodiment, the end point of the polishing process may be accurately calculated.

The thickness-spectrum database 70 includes data on the spectrum and the polishing time according to the thickness of the second inorganic layer 120 to which the polishing process is applied, which will be described in more detail with reference to FIGS. 5 to 9.

Hereinafter, the principle of a method for monitoring polishing according to an embodiment will be described in more detail with reference to FIGS. 5 to 7.

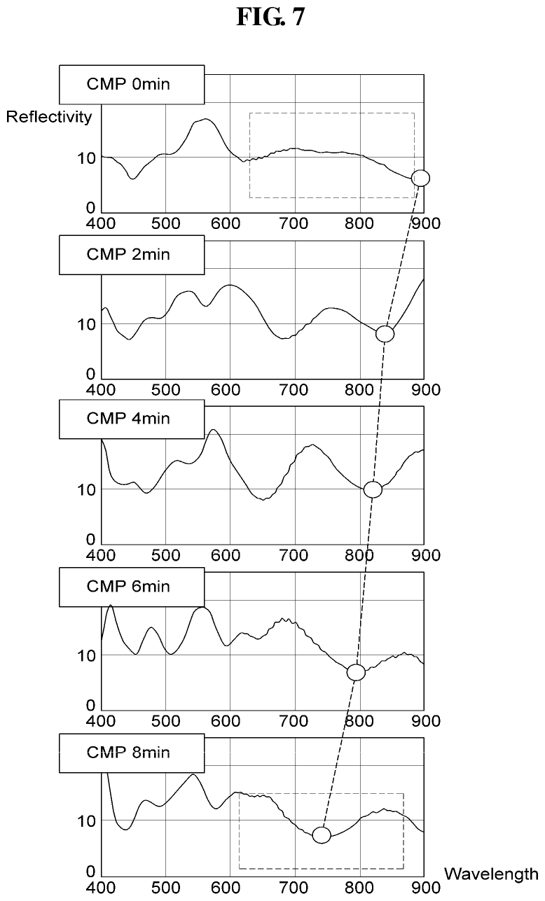

FIG. 5 is a cross-sectional view illustrating a substrate before polishing, FIG. 6 is a cross-sectional view illustrating a substrate after polishing, and FIG. 7 is a view illustrating spectra of reflected lights according to a degree of polishing.

Referring to FIGS. 5 and 6, the substrate 100 to which the polishing process according to an embodiment is applied is a display substrate including display pixels, and may be, for example, one selected from a liquid crystal display (LCD) substrate and an organic light emitting diode (OLED) display substrate. In some embodiments, as illustrated in FIG. 5, the substrate 100 to which the polishing process is applied may include a plurality of patterns, and may include a first inorganic layer 110 and a second inorganic layer 120 sequentially covering the patterns. Accordingly, each of the first inorganic layer 110 and the second inorganic layer 120 may have a step difference due to the pattern included in the substrate 100.

Each of the first inorganic layer 110 and the second inorganic layer 120 may include silicon oxide (SiOₓ) or silicon nitride (SiNₓ), for example. In addition, each of the first inorganic layer 110 and the second inorganic layer 120 may further include aluminum oxide, titanium oxide, tantalum oxide, or zirconium oxide. For example, the first inorganic layer 110 may include silicon nitride (SiNₓ), and the second inorganic layer 120 may include silicon oxide (SiOₓ).

When the polishing process is applied to the substrate 100 that includes the first inorganic layer 110 and the second inorganic layer 120, a part of the second inorganic layer 120 is removed as illustrated in FIG. 6, and thus, an upper surface of the substrate 100 including the first inorganic layer 110 and the second inorganic layer 120 is planarized.

A first light L1 emitted from the light irradiation unit 51 is reflected and interfered at interfaces between a plurality of layers included in the substrate 100, and is input as a second light L2 to the light detection unit 52. Because the second light L2 is a light that has been reflected and interfered at the interfaces of the plurality of layers, it is difficult to accurately measure a thickness of one layer located at the substrate 100. However, a spectrum of the reflected light of the substrate 100 varies depending on the thickness of one layer at the substrate 100. In some embodiments, as the thickness of the second inorganic layer 120 decreases, a wavelength of the second light L2 becomes shorter. For example, as the polishing time for which the polishing process is performed increases, the thickness of the second inorganic layer 120 decreases. Further, as the thickness of the second inorganic layer 120 decreases, the wavelength of the spectrum of the reflected light of the substrate 100 decreases. Accordingly, wavelengths at a peak point and a valley point of the spectrum calculated by the monitoring unit 50 may vary according to the thickness of the second inorganic layer 120.

According to an embodiment, a thickness-spectrum database including data on reference spectra corresponding to the thicknesses of the second inorganic layer 120, respectively, is generated, and wavelengths of a peak point and a valley point of the spectrum calculated by the monitoring unit 50 are analyzed to compare them with wavelengths of a peak point and a valley point of the reference spectrum, and thus, the thickness of the second organic layer 120 may be calculated.

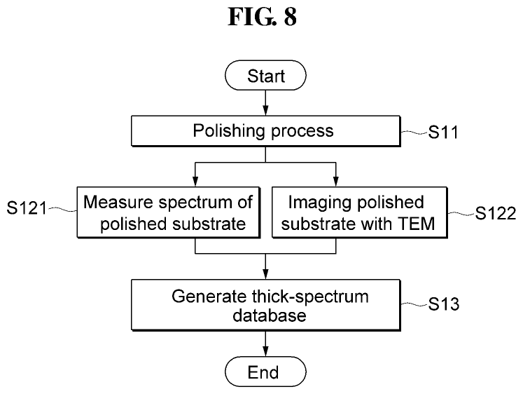

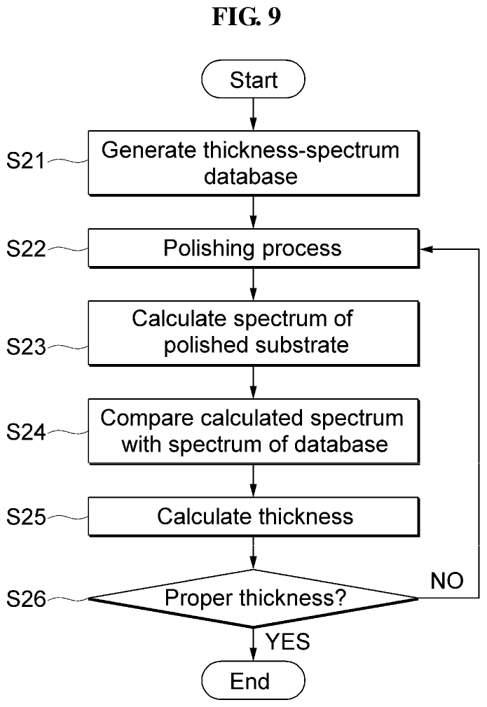

Hereinafter, a method for monitoring polishing according to an embodiment will be described in more detail with reference to FIGS. 8 to 9.

FIG. 8 is a flowchart illustrating a method for generating a thickness-spectrum database 70 according to an embodiment.

According to an embodiment, the end point of the polishing process is determined by using the thickness-spectrum database 70, and feedback on the thickness of the second inorganic layer 120 is provided. To this end, the thickness-spectrum database 70 is generated.

First, the polishing unit 20 polishes a part of the second inorganic layer 120 by performing a polishing process on the substrate 100 that includes the first inorganic layer 110 and the second inorganic layer 120 (S11). Accordingly, as illustrated in FIG. 6, the substrate 100 includes at least a part of the second inorganic layer 120. Subsequently, the substrate 100 is transferred by the substrate transferring unit 10 toward the cleaning unit 30, the drying unit 40 and the monitoring unit 50 along the first direction D1. Accordingly, the substrate 100 is cleaned and dried by the cleaning unit 30 and the drying unit 40.

The monitoring unit 50 measures the spectrum of the reflected light of the substrate 100 (S121). In some embodiments, the light irradiation unit 51 emits a visible light or an infrared light to the substrate 100, and the optical probe 52a receives a visible light or an infrared light that is reflected from the substrate 100. The multi-channel spectroscope 52b may calculate the luminous intensity over a set or predetermined wavelength range by decomposing the reflected light input thereto according to wavelength.

Along with the measurement of the spectrum, the thickness of the second inorganic layer 120 that remains is measured from a cross-section of the substrate 100 that is obtained using a transmission electron microscope (S122).

The monitoring unit 50 may calculate the reference spectra corresponding to the thicknesses of the second inorganic layer 120, respectively. Accordingly, the thickness-spectrum database 70 including data on the reference spectra respectively corresponding to the thicknesses of the second inorganic layer 120 is generated (S13). In such an embodiment, the thickness-spectrum database 70 may include data on the end point of the polishing process that indicates the polishing time, in addition to the reference spectra corresponding to the thicknesses.

According to an embodiment, the controller 60 may compare the spectrum calculated by the monitoring unit 50 with the reference spectrum, and thus, may calculate the thickness of the second inorganic layer 120 and the end point of the polishing process.

FIG. 9 is a flowchart illustrating a method for monitoring polishing according to an embodiment.

Referring to FIGS. 8 and 9, first, the thickness-spectrum database 70 is generated as described above (S21).

After the thickness-spectrum database 70 is generated, the polishing process and monitoring start. The polishing unit 20 performs a polishing process on the substrate 100 that is on the substrate transferring unit 10 (S22). In some embodiments, the controller 60 receives the end point of the polishing process from the thickness-spectrum database 70 and outputs it to the polishing unit 20, so that the polishing unit 20 may polish the second inorganic layer 120 until the end point of the polishing process. Accordingly, an upper surface of the second inorganic layer 120 illustrated in FIG. 5 may be polished, and may be planarized into the upper surface of the second inorganic layer 120 illustrated in FIG. 6.

After the second inorganic layer 120 is polished, the substrate 100 is transferred by the substrate transferring unit 10 along the first direction D1, and the cleaning solution remaining at the substrate 100 is removed by the cleaning unit 30 and the drying unit 40.

The monitoring unit 50 emits a light to the substrate 100, measures a reflected light, and calculates a spectrum of the reflected light (S23). In some embodiments, the light irradiation unit 51 emits the light to the substrate 100, and the optical probe 52a receives the reflected light from the substrate 100. The multi-channel spectroscope 52b decomposes the reflected light input through the optical probe 52a according to wavelength to calculate the spectrum.

According to an embodiment, because the plurality of optical probes 52a are arranged corresponding to the plurality of cells 101, 102, and 103 of the substrate 100, respectively, the monitoring unit 50 concurrently (e.g., simultaneously) calculates each spectrum for different positions of the substrate 100. A method for monitoring polishing according to an embodiment may measure evenness of the second inorganic layer 120 to which the polishing process is applied, and evenness of the substrate 100 that includes the second inorganic layer 120.

The controller 60 compares the calculated spectrum of the reflected light with the reference spectrum (S24). For example, the controller 60 may find one of reference spectra that has a peak point or a valley point at a wavelength substantially the same as a wavelength at which the spectrum calculated by the monitoring unit 50 has a peak point or a valley point.

The controller 60 calculates the thickness of the second inorganic layer 120 (S25). In some embodiments, the controller 60 finds a reference spectrum that has a peak point or a valley point at a wavelength substantially the same as a wavelength at which the spectrum calculated by the monitoring unit 50 has a peak point or a valley point, and calculates the thickness of the second inorganic layer 120 corresponding to the reference spectrum.

The controller 60 determines whether the thickness of the second inorganic layer 120 is a proper thickness (S26). When the thickness of the second inorganic layer 120 is within a set or predetermined range, the thickness of the second inorganic layer 120 may be determined to be suitable or appropriate, and the controller 60 ends the method for monitoring polishing. When the thickness of the second inorganic layer 120 is out of the set or predetermined range, it may be determined that the thickness of the second inorganic layer 120 is not suitable or not appropriate, and accordingly, a polishing time to further proceed may be calculated, and the polishing process may be resumed.

In addition, the controller 60 compares each of the thicknesses calculated based on the respective spectra measured concurrently (e.g., simultaneously) by the plurality of optical probes 52a with each other. Accordingly, the evenness of the second inorganic layer 120 may be determined. When it is determined that the substrate 100 is even (e.g., substantially even), the thickness of the second inorganic layer 120 may be determined to be suitable or appropriate, and the controller 60 ends the method for monitoring polishing. When it is determined that the thickness of the second inorganic layer 120 is not even, it may be determined that the thickness of the second inorganic layer 120 is not suitable or not appropriate, and accordingly, the controller 60 may calculate a polishing time to further proceed, and may resume the polishing process.

As set forth hereinabove, according to one or more embodiments of the present disclosure, an apparatus and a method for monitoring polishing are capable of accurately determining an end point of a polishing process and measuring evenness of a substrate.

While the subject matter of the present disclosure has been illustrated and described with reference to embodiments thereof, it will be apparent to those of ordinary skill in the art that various changes in form and detail may be made thereto without departing from the spirit and scope of the present disclosure.

What is claimed is:

1. An apparatus for monitoring polishing, the apparatus comprising:
a substrate transferring unit for transferring a substrate that comprises at least one inorganic layer along a first direction;
a polishing unit on the substrate transferring unit;
a cleaning unit and a drying unit on the substrate transferring unit; and
a monitoring unit on the substrate transferring unit, the monitoring unit comprising a plurality of optical probes configured to measure reflected lights reflected from respective ones of a plurality of different positions of the substrate,
wherein the polishing unit, the cleaning unit, the drying unit, and the monitoring unit are sequentially located along the first direction.

2. The apparatus of claim 1, wherein the plurality of optical probes are spaced apart from each other along a second direction that is perpendicular to the first direction.

3. The apparatus of claim 1, wherein the substrate comprises a plurality of cells arranged along the first direction and a second direction that is perpendicular to the first direction, and
the plurality of optical probes are arranged to correspond to respective ones of the cells of the substrate.

4. The apparatus of claim 1, further comprising a thickness-spectrum database comprising data on thicknesses of the inorganic layer, and reference spectra corresponding to respective ones of the thicknesses of the inorganic layer.

5. The apparatus of claim 4, wherein the thickness-spectrum database comprises data on polishing times corresponding to respective ones of the thicknesses of the inorganic layer.

6. The apparatus of claim 4, further comprising a multi-channel spectroscope coupled to the plurality of optical probes, and the multi-channel spectroscope being configured to calculate spectra from respective ones of the reflected lights measured by the plurality of optical probes.

7. The apparatus of claim 6, further comprising a controller configured to compare the plurality of calculated spectra with the reference spectra.

8. The apparatus of claim 7, wherein the controller is configured to compare wavelengths at a peak point and a valley point of a spectrum calculated by the multi-channel spectroscope with respective ones of wavelengths at a peak point and a valley point of the reference spectrum.

9. The apparatus of claim 7, wherein the controller is configured to compare the plurality of calculated spectra with each other.

10. A method for monitoring polishing, the method comprising:
generating a thickness-spectrum database;
polishing a substrate that comprises at least one inorganic layer;
concurrently calculating spectra for respective ones of a plurality of different positions of the substrate;
comparing each of the calculated spectra with reference spectra comprised in the thickness-spectrum database;
calculating thicknesses of the inorganic layer at respective ones of the plurality of different positions of the substrate; and
determining properness of the thicknesses of the inorganic layer at the respective ones of the plurality of different positions of the substrate.

11. The method of claim 10, wherein, when concurrently calculating the spectra for the plurality of different positions of the substrate, respectively, the plurality of different positions of the substrate correspond to respective ones of a plurality of cells comprised in the substrate.

12. The method of claim 10, wherein the determining of the properness of the thicknesses of the inorganic layer at the plurality of different positions of the substrate comprises:
comparing thicknesses calculated for the respective ones of the plurality of different positions of the substrate with each other; and
determining evenness of the inorganic layer.

13. The method of claim 10, wherein the thickness-spectrum database comprises data on thicknesses of the inorganic layer, and reference spectra corresponding to the respective ones of thicknesses of the inorganic layer.

14. The method of claim 10, wherein the thickness-spectrum database comprises data on polishing times corresponding to the respective ones of the thicknesses of the inorganic layer.

15. The method of claim 10, wherein the concurrently calculating of the spectra for the respective ones of the plurality of different positions of the substrate comprises:
measuring reflected lights reflected from respective ones of the plurality of different positions of the substrate; and
decomposing each of the reflected lights of the substrate according to wavelength.

16. The method of claim 10, wherein the comparing of each of the calculated spectra with the reference spectra comprised in the thickness-spectrum database comprises:
comparing wavelengths at a peak point and a valley point of the calculated spectrum with respective ones of wavelengths at a peak point and a valley point of the reference spectrum.

17. The method of claim 10, wherein the concurrently calculating of the spectra for the respective ones of the plurality of different positions of the substrate comprises:
measuring a luminous intensity of each of the reflected lights according to a wavelength of about 400 nm or more and about 900 nm or less.

18. The method of claim 10, wherein the generating of the thickness-spectrum database comprises:
performing a polishing process on each of the plurality of substrates, each comprising at least one inorganic layer;
calculating a spectrum for each of the plurality of substrates;
measuring a thickness of the inorganic layer of each of the plurality of substrates using a transmission electron microscope; and
calculating a thickness of the inorganic layer and a reference spectrum for each of the plurality of substrates corresponding to the thickness of the inorganic layer.

19. A method for monitoring polishing, the method comprising:
performing a polishing process on each of a plurality of substrates, each comprising at least one inorganic layer;
calculating a spectrum for each of the plurality of substrates;
measuring a thickness of the inorganic layer of each of the plurality of substrates using a transmission electron microscope; and
calculating a thickness of the inorganic layer and a reference spectrum for each of the plurality of substrates corresponding to the thickness of the inorganic layer.

20. The method of claim 19, wherein the calculating of the thickness of the inorganic layer and the reference spectrum for each of the plurality of substrates corresponding to the thickness of the inorganic layer comprises:
calculating wavelengths at a peak point and a valley point of the reference spectrum corresponding to the thickness of the inorganic layer.
